(19) United States
(12) Patent Application Publication
(10) Pub. No.: US 2025/0178901 A1
(43) Pub. Date: Jun. 5, 2025

(54) METHOD FOR PRODUCING LITHIUM FLUOROSULFONYL IMIDE SALTS

(71) Applicant: SPECIALTY OPERATIONS FRANCE, Lyon (FR)

(72) Inventors: Etienne Schmitt, Soucieu-En-Jarrest (FR); Elie Derrien, Brignais (FR)

(73) Assignee: SPECIALTY OPERATIONS FRANCE, Lyon (FR)

(21) Appl. No.: 18/844,893

(22) PCT Filed: Feb. 24, 2023
(86) PCT No.: PCT/EP2023/054725

§ 371 Date: Sep. 6, 2024

(30) Foreign Application Priority Data
Mar. 7, 2022 (EP) 22305260.6

(51) Int. Cl. C01B 21/086; H01M 10/0568

(52) U.S. Cl. CPC C01B 21/086; H01M 10/0568; C01P 2006/40; C01P 2006/80; H01M 2300/0025

(57) ABSTRACT

The present invention relates to a method producing a lithium salt of bis(fluorosulfonyl)imide.

### REFERENCE TO RELATED APPLICATION

This application claims priority to earlier European Patent Application filed on 7 Mar. 2022 with Nr 22305260.6, the whole content of this application being incorporated herein by reference for all purposes.

### TECHNICAL FIELD

The present invention relates to a method producing a lithium salt of bis (fluorosulfonyl) imide.

### BACKGROUND

Fluorosulfonylimide salts, in particular the lithium salt of bis (fluorosulfonyl) imide (LiFSI), are useful compounds for battery electrolytes. Different processes, reactants and intermediates leading to LiFSI have been described in the patent literature, notably patent CA 2 527 802 (Université de Montréal) which lists several routes to prepare LiFSI, for example the process for preparing LiFSI in one step starting from bis(chlorosulfonyl)imide (HCSI) using anhydrous hydrogen fluoride (HF):

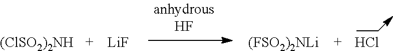

One of the alternate known processes to prepare LiFSI is a two-step process and involves the fluorination of bis(chlorosulfonyl)imide (HCSI) into bis(fluorosulfonyl)imide (HFSI) using a fluorination agent, for example anhydrous hydrogen fluoride (HF), and then the lithiation of HFSI into LiFSI using a lithiation agent.

Another known two-step process for preparing LiFSI involves a first step of fluorination of bis(chlorosulfonyl)imide (HCSI) into ammonium bis(fluorosulfonyl)imide (NH₄FSI) using NH₄F(HF)ₓ as a fluorinating agent, followed by a second step of lithiation of NH₄FSI, leading then to the LiFSI product. Such a process is described for example in WO 2017/090877 A1 (CLS) and EP 3 170 789 A1 (Nippon Soda).

Another known two-step process for preparing LiFSI involves the lithiation of HCSI in a first step using a lithiation agent in order to prepare LiCSI as an intermediate product, and then the fluorination of LiCSI into LiFSI using a fluorination agent. For example, KR 20200049164 (CLS) relates to a LIFSI preparation method, comprising a step reacting HCSI with various lithiation reagents in an (S1) solvent to produce LiCSI and then reacting it with an anhydrous fluorination reagent directly without purification. A long list of possible solvents is given in the specification, while dimethyl carbonate is used in the examples.

As can be read from the patent literature above-cited, the production of bis(fluorosulfonyl)imide, salts thereof and intermediate products, takes place in solvents, for example organic solvents, in order to disperse the reactive entities and allow them to react.

### SUMMARY OF THE INVENTION

The Applicant perceived that there is still the need in the art for improving the manufacturing process of LiFSI and of the intermediate compounds for its manufacture.

In particular, the Applicant is aware that the organic solvents used in the processes disclosed in the prior art usually might have to be treated to remove the residual amount of water and/or need to be removed after the reaction. This step for removing the solvent adds to the complexity of the industrial process, as well as its overall cost.

With the aim of overcoming the above drawbacks, the Applicant faced the problem of providing a simpler production process for preparing LiCSI product, which notably does not require the use of a solvent.

In a first aspect, the present invention related to a method for producing a lithium salt of bis(fluorosulfonyl)imide (LiFSI) comprising the steps of:
(a) providing lithium salt of bis(chlorosulfonyl)imide (LiCSI) having a solvent content below 1000 ppm, preferably below 500 ppm and more preferably below 100 ppm, as determined by gas chromatography or headspace gas chromatography; and (b) contacting the LiCSI of step (a) with at least one fluorinating agent, so as to produce LiFSI.

In a second aspect, the present invention relates to lithium bis(fluoro sulfonyl)imide (LiFSI), obtainable by the method of the present invention.

In a third aspect, the present invention relates to the use of the lithium bis(fluorosulfonyl)imide (LiFSI), as described above, in electrolytes for batteries, such as notably non-aqueous electrolytes, which can subsequently be used in the manufacture of batteries or battery cells by positioning it between a cathode and an anode.

### DETAILED DESCRIPTION

In the present application:
the expression “between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents;
the term “solvent” is intended to mean a compound which presents the following three cumulative properties of 1/being present from the beginning to the end of the reaction, possibly added during the process, 2/unchanged during the process, in other words non-reactive towards the involved reactants, and 3/having to be removed at the end of the process in case the reaction product is to be in its pure form. For sake of clarity, the molten HCSI used in the process of the present invention does not fall in the definition of and is not intended as “solvent” or “diluent” as above-mentioned. Solvents which are typically used in such processes are well-known and extensively described in the literature. Such solvents may be aprotic, for example polar aprotic solvents, and may selected from the group consisting of:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide, and
cyano-, nitro-, chloro- or alkyl-substituted alkane or aromatic hydrocarbon, for instance acetonitrile, valeronitrile, adiponitrile, benzonitrile, nitromethane, nitrobenzene.

Under step (a), the LiCSI having a solvent content below 100 ppm is preferably manufactured via a method [method (M-I)] comprising the following steps:
(A) providing bis (chlorosulfonyl) imide (HCSI)
(B) melting said HCSI obtained in step (a) to obtain a molten HCSI and
(C) contacting said molten HCSI obtained in step (b) with a compound of formula (I):

M⁺B⁻ (I)

wherein
M is selected from Na, Li, K, Ce, Rb and Fr and
B is selected from Cl; F; carbonate (CO₃²⁻); sulphate (SO₄²⁻); carboxylate; silicate, preferably metasilicate; borate, preferably tetraborate; and mixtures thereof; and allow the reaction to proceed, to produce the salt of bis (chlorosulfonyl) imide,
   wherein steps (B) and (C) are carried out in the absence of solvent.

The salt of bis (chlorosulfonyl) imide obtained with said method (M-I) is characterised by a non-detectable amount of solvent, which makes it well-suited for many applications, notably as an intermediate to prepare LiFSI used in battery applications.

Advantageously, the method (M-I) is carried out in molten HCSI, which acts to disperse the compound of formula (I), in the absence of solvents and diluents. In other words, the method of the present invention is a solvent-free method, which means that no solvent and/or diluent is added to the reaction mixture during the reaction. This is advantageous because first, the step for removing the solvent is avoided, thus reducing the complexity of the industrial process, as well as its overall cost and secondly, the preliminary step of treating the solvent to decrease its moisture content is also avoided.

In the context of the present invention, the starting HCSI as provided in step (A) of method (M-I) may be produced by a known method, for example:
by reacting chlorosulfonyl isocyanate (ClSO₂NCO) with chlorosulfonic acid (ClSO₂OH);
by reacting cyanogen chloride (CNCl) with sulfuric anhydride (SO₃), and with chlorosulfonic acid (ClSO₂OH); or
by reacting sulfamic acid (NH₂SO₂OH) with thionyl chloride (SOCl₂) and with chlorosulfonic acid (ClSO₂OH).

According to the method of the present invention, in step (B) a quantity of HCSI is heated above its melting temperature (Tm_{HCSI}), before the addition of the compound of formula (I), in order to be in a molten state (also called liquid state).

Preferably, step (B) is performed at a temperature (Tb) suitable for melting HCSI and maintaining HCSI in the molten state, while its degradation is avoided.

Step (B) is conducted at a temperature (Tb) equal to or above the melting point (Tm) of HCSI (Tm_{HCSI}). In this case, Tb≥Tm_{HCSI}. For example, Tb may be equal to or above the melting point Tm of HCSI (Tm_{HCSI}) plus 5° C. In this case, Tb≥Tm_{HCSI}+5. As another example, Tb may be equal to or above the melting point Tm of HCSI (Tm_{HCSI}) plus 10° C. In this case, Tb≥Tm_{HCSI}+10.

The person skilled in the art will understand that the Tm of HCSI is influenced by the presence and amounts of impurities.

Preferably, the temperature (Tb) at which step (B) is conducted is equal to or higher than 30° C., for example equal to or higher than 37° C., for example equal to or higher than 38° C., equal to or higher than 40°° C., equal to or higher than 45° C. or even equal to or higher than 50° C. In any case, the temperature (Tb) at which step (B) is conducted is below the degradation temperature of HCSI.

Preferably, under step (C), said compound of formula (I) is added into the reaction mixture, either progressively or at once.

Alternatively, molten HCSI is added, either progressively or at once, to said compound of formula (I) previously loaded in a reactor.

The person skilled in the art will understand that other ingredients or reactants, either in a powder form or in a liquid form, can be added to the reaction environment based on the needs or circumstances.

In some embodiments, the molar ratio HCSI to the compound of formula (I) ranges from 0.001:1 to 20:1, in particular from 0.1:1 to 10:1, more particularly from 0.5:1 to 5:1, even more particularly being about 1:1.

Preferably, in said compound of formula (I), M is selected from Na, Li and K.

Even more preferably, M is Li. According to this embodiment, the compound of formula (I) will be referred to as “compound LiX”.

According to this embodiment, the compound LiX to be used in the method of the invention is a component, which does not generate water or soluble species over the course of the reaction.

In some preferred embodiments, said compound LiX is selected from the group consisting of lithium chloride (LiCl), lithium fluoride (LiF), lithium carbonate (Li₂CO₃), lithium sulphate (Li₂SO₄), lithium carboxylate (Liₙ(RCO₂)ₙ), Li₂SiO₃, Li₂B₄O₇ and mixtures thereof.

Even more preferably, said compound LiX is anhydrous lithium chloride (LiCl) in a solid form.

Depending on the circumstances, said step (B) and step (C) can be conducted at the same temperature or at different temperatures.

The person skilled in the art will understand that the choice of the compound of formula (I) influences the temperature at which step (C) is performed. Detailed description of step (C) as provided hereinafter refers to the step in which in compound (I), M is Li and hence the salt as obtained at the end of step (C) is lithium bis (chlorosulfonyl) imide (LiCSI).

Preferably, when step (C) is conducted at a temperature (Tc) at which LiCSI is in a liquid form, which is a temperature equal to or above the melting point (Tm) of LiCSI (Tm_{LiCSI}). In this case, Tc≥Tm_{LiCSI}. For example, (Tc) may be equal to or above the melting point Tm of LiCSI (Tm_{LiCSI}) plus 5° C. In this case, Tc≥Tm_{LiCSI}+5. As another example, Tc may be equal to or above the melting point Tm of LiCSI (Tm_{LiCSI}) plus 10° C. In this case, Tc≥Tm_{LiCSI}+10.

Alternatively and more preferably, step (C) is conducted at a temperature (Tc) such that HCSI is in a molten state, i.e. Tc≥Tm_{HCSI}, and LiCSI is, at least partially, in solid form, i.e. Tc≤Tm_{LiCSI}. According to this embodiment, Tc may be equal to or below the melting point Tm of LiCSI (Tm_{LiCSI}) minus 5° C. In this case, Tc≤Tm_{LiCSI}−5. As another example, Tc may be equal or below the melting point Tm of LiCSI (Tm_{LiCSI}) minus 10° C. In this case, Tc≤Tm_{LiCSI}−10. In other words, according to these embodiments, the temperature Tc at which step (C) is conducted varies between the melting point of HCSI (Tm_{HCSI}) and the melting point of LiCSI (Tm_{LiCSI}).

Preferably, the temperature (Tc) at which step (C) is conducted is equal to or higher than 37° C., for example equal to or higher than 50° C., equal to or higher than 60° C., equal to or higher than 80° C. or even equal to or higher than 100° C. In some embodiments, the temperature (Tc) at which step (C) is conducted is equal to or less than 220° C., for example equal to or less than 218° C., equal to or less than 215°° C., equal to or less than 212° C. or even equal to or higher than 210° C.

Each of step (B) and/or step (C) may be conducted at atmospheric pressure or under reduced pressure. For example, each of step (B) and step (C) may be conducted under vacuum or at a pressure around 1 atm, preferably 1 atm.

In embodiments in which the temperature (Tc) at which step (C) is conducted varies between the melting point of HCSI (Tm₁) and the melting point of LiCSI (Tm₂), the molar ratio HCSI to compound LiX is preferably such that HCSI is the excess reactant, so that non converted HCSI make the final reaction medium processable for further LiCSI filtration. For example, the molar ratio HCSI to compound LiX is 2:1.

In other embodiments in which temperature (Tc) at which step (C) is conducted is higher or equal to the melting point of LiCSI (Tm₂), the molar ratio HCSI to compound LiX is preferably such that compound LiX is the excess reactant, so that HCSI can be fully converted and compound LiX filtrated to provide isolated LiCSI. For example, the molar ratio HCSI to compound LiX is 1:1.05.

Preferably, when LiCl is used, the hydrogen chloride (HCl) formed as a by-product during step (B) and/or step (C) is continuously removed from the reaction vessel during step (B) and/or step (C). For example, HCl removal is performed under vacuum or by stripping using an inert gas (such as nitrogen, helium or argon) flow in the reaction vessel sky or inside the liquid reaction mixture. The sparged HCl can be further recycled.

Preferably, the method according to the present invention comprises after step (C), a step (D) comprising the separation of the salt of bis (chlorosulfonyl) amide (LiCSI) from the reaction mixture. When the method comprises step (D), the HCSI remaining after the reaction can be reused. The remaining HCSI is preferably in the molten state.

This separation step may be performed by any separation means known by the person skilled in the art. Separation may be performed for example by filtration, for instance under pressure or under vacuum, or decantation. Mesh size of the filtration medium may be for example 2 μm or below, of 0.45 μm or below, or of 0.22 μm or below. The separated product(s) may be washed once or several times with appropriate solvent, which can be determined by the person skilled in the art, such as for example dichloromethane and the like. Preferably, said solvent is then evaporated and the recovered HCSI can be recycled. The separation step may be carried out one time or may be repeated twice or more if necessary.

Some of the steps or all steps of the method according to the invention are advantageously carried out in equipment capable of withstanding the corrosion of the reaction medium.

For this purpose, materials are selected for the part in contact with the reaction medium that are corrosion-resistant, such as the alloys based on molybdenum, chromium, cobalt, iron, copper, manganese, titanium, zirconium, aluminium, carbon and tungsten, sold under the Hastelloy® brands or the alloys of nickel, chromium, iron and manganese to which copper and/or molybdenum are added, sold under the name Inconel® or Monel™M, and more particularly the Hastelloy C276 or Inconel 600, 625 or 718 alloys. Stainless steels may also be selected, such as austenitic steels and more particularly the 304, 304L, 316 or 316L stainless steels. A steel having a nickel content of at most 22 wt. %, preferably of between 6 wt. % and 20 wt. % and more preferentially of between 8 wt. % and 14 wt. %, is used. The 304 and 304L steels have a nickel content that varies between 8 wt. % and 12 wt. %, and the 316 and 316L steels have a nickel content that varies between 10 wt. % and 14 wt. %. More particularly, 316L steels are chosen. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass and glass-lined as well as enamel equipment may also be used. It will not be outside the scope of the invention to use an equivalent material. Materials for filtration have to be compatible with the medium used. Fluorinated polymers (PTFE, PFA), loaded fluorinated polymers (Viton™), and other compatible materials can be used.

All raw materials used in the method according to the invention, including reactants, may preferably show very high purity. Preferably, their content of metal components such as Na, K, Ca, Mg, Fe, Cu, Cr, Ni, Zn, is below 10 ppm, more preferably below 5 ppm, or below 2 ppm.

Other methods known to the person skilled in the art can be used for the manufacture of salt of bis (chlorosulfonyl) imide having a solvent content below 1000 ppm.

Preferably, said LiCSI as obtained at the end of step (a) is in its molten state or crystallised.

The LiCSI may be dissolved into an organic solvent, for further use.

The fluorinating agent used in step (b) of the process of the present invention may be in any form, for example in the form of a powder, in the form of a liquid or in a gaseous form. Fluorinating agents are commercially available, or they may be produced by a known method.

In some embodiments, step (b) is performed directly with the LiCSI, for example in a molten form or in a solid form, as obtained from step (a), for example without any further purification.

The fluorinating agent used in the process of the present invention may be anhydrous hydrogen fluoride (HF). Such anhydrous hydrogen fluoride preferably has a high purity, for example above 99.95 mol. %, with less than 1000 ppm of H₂O, less than 10 ppm of SO₂, less than 100 ppm of H₂SO₄, less than 20 ppm of H₂SiF₆ and less than 25 ppm of As.

When anhydrous hydrogen fluoride is used as a fluorinating agent in step b), it may be introduced in any form in the reaction mixture. It may be introduced as a liquid or it can be introduced as a gas in the reaction vessel. It may be introduced in the molten LiCSI or in the organic solvent dispersing the LICSI obtained from step (a). It may be introduced in a liquid form or in a gas form. It may also be introduced as a gas in the gas phase of the reaction vessel. The anhydrous hydrogen fluoride may be dispersed in the reaction mixture by any means known from the skilled person.

For example, step (b) can be performed by fluorinating the LiCSI using HF gas in a fluidized bed.

According to other embodiments, the fluorinating agent is selected from the group comprising, preferably consisting of:
(i) KF(HF)ₚ wherein p is 0 or 1;
(ii) NaF(HF)ₚ wherein p is 0 or 1;
(iii) X₂F(HF)ₚ wherein X₂ is an onium cation, and p is 0 or 1;
(iv) NH₄F(HF)ₚ wherein p varies between 0 and 10;
(v) LiF;
(vi) ZnF₂.

According to a preferred embodiment, specific examples of the fluorinating agent (iv) include NH₄F, NH₄F·HF, NH₄F·2HF, NH₄F·3HF, and NH₄F.4HF.

The preferred fluorinating agent (iv) is NH₄F.

In the present invention, the fluorinating agent used in step b) is preferably anhydrous. Moisture content may be preferably below 100 ppm, below 50 ppm or even below 10 ppm. The skilled person can determine the most suitable method to determine such moisture content. For example, such methods can include infrared techniques or Karl Fischer titration where applicable.

In some embodiments, the stoichiometry amount (also called molar amount) of fluorinating agent to LiCSI is from 0.1:1 to 50:1, for example from 1:1 to 10:1, or from 2:1 to 8:1.

In some embodiments, the stoichiometry amount of fluorinating agent is not less than 2 equivalent per 1 mol of LiCSI, for example between 2 to 100 equivalents per 1 mol of LiCSI. Preferably, the stoichiometry amount of fluorinating agent is between 2 to 80 equivalents per 1 mol of LiCSI, or between 2 to 60 equivalents per 1 mol of LiCSI. More preferably, the stoichiometry amount of fluorinating agent is between 2 to 50 equivalents per 1 mol of LiCSI.

The process described herein may be carried out in a batch, semi-batch or continuous mode.

The residual HF present in the final reaction crude may be eliminated using any relevant method such as vaporisation under vacuum or stripping using an inert gas or the combination thereof.

The LiFSI as obtained with the method of the present invention advantageously shows at least one of the following features, and preferably all the following:
a purity of at least 98 wt. %, for example between 99 wt. % and 100 wt. % or between 99.50 and 100%, as determined by 19F NMR;
a solvent content of less than 20 wt. %, less than 10 wt. %, less than 1 wt. %, preferably between 0 wt. % and 1 wt. %, as determined by GC;
a moisture content of less than 500 ppm, less than 100 ppm, less than 50 ppm or even less than 20 ppm, as determined by infrared methods.

The LiFSI of the present invention advantageously shows at least one of the following features, and preferably all the following:
a chloride (Cl⁻) content of below 100 ppm, preferably below 50 ppm, more preferably below 10 ppm, or more preferably below 2 ppm;
a fluoride (F⁻) content of below 100 ppm, preferably below 50 ppm, more preferably below 40 ppm, more preferably below 30 ppm, more preferably below 20 ppm; and
a sulfate (SO₄²⁻) content of below 100 ppm, preferably below 50 ppm, more preferably below 10 ppm, or more preferably below 2 ppm.

Fluoride and chloride contents may be measured by means of titration by argentometry using ion selective electrodes (or ISE). Sulfate content may be measured by ionic chromatography or by turbidimetry.

Preferably, it may show at least one of the following contents of metal elements, and preferably all:
an iron (Fe) content of below 100 ppm, preferably below 50 ppm, more preferably below 10 ppm and even more preferably below 1 ppm;
a chromium (Cr) content of below 100 ppm, preferably below 50 ppm, more preferably below 10 ppm and even more preferably below 1 ppm;
a nickel (Ni) content of below 100 ppm, preferably below 50 ppm, more preferably below 10 ppm and even more preferably below 1 ppm.;
a zinc (Zn) content of below 100 ppm, preferably below 50 ppm, more preferably below 10 ppm and even more preferably below 1 ppm.;
a copper (Cu) content of below below 100 ppm, preferably below 50 ppm, more preferably below 10 ppm and even more preferably below 1 ppm.;
a manganese (Mg) content of below 100 ppm, preferably below 50 ppm, more preferably below 10 ppm and even more preferably below 1 ppm;
a sodium (Na) content of below 100 ppm, preferably below 50 ppm, more preferably below 10 ppm and even more preferably below 1 ppm.;
a potassium (K) content of below 100 ppm, preferably below 50 ppm, more preferably below 10 ppm and even more preferably below 1 ppm;
a (Pb) content of below 100 ppm, preferably below 50 ppm, more preferably below 10 ppm and even more preferably below 1 ppm.

Elemental impurity content may be measured by ICP-AES (inductively coupled plasma); more specifically, Na content may be measured by AAS (atomic absorption spectroscopy).

Advantageously, the lithium bis(fluorosulfonyl)imide (LiFSI) prepared according to the method of the present invention can be used in an electrolyte composition for an electrochemical cell.

In a further aspect, the present invention to an electrolyte composition comprising the LiFSI as obtained with the method of the present invention. advantageously, said electrolyte composition is a non-aqueous electrolyte composition.

Should the disclosure of any patents, patent applications, and publications which are incorporated herein by reference conflict with the description of the present application to the extent that it may render a term unclear, the present description shall take precedence.

1. A method for producing a lithium salt of bis(fluororosulfonyl)imide (LiFSI) comprising the step of:
(a) providing lithium salt of bis(chlorosulfonyl)imide (LiCSI) having a solvent content below 1000 ppm, as determined by gas chromatography or headspace gas chromatography; and
(b) contacting the LiCSI of step (a) with at least one fluorinating agent, so as to produce LiFSI.

2. The method according to claim 1, wherein said LiCSI is in the molten form or in the solid form.

3. The method according to claim 1, wherein said LiCSI has a solvent content below 500 ppm as determined by gas chromatography or headspace gas chromatography.

4. The method according to claim 3, wherein said fluorinating agent is selected from anhydrous hydrogen fluoride (HF) or from the group comprising:
(i) KF(HF)ₚ wherein p is 0 or 1;
(ii) NaF(HF)ₚ wherein p is 0 or 1;
(iii) X₂F(HF)ₚ wherein X₂ is an onium cation, and p is 0 or 1;
(iv) NH₄F(HF)ₚ wherein p varies between 0 and 10;
(v) LiF; and
(vi) ZnF₂.

5. The method according to claim 1, wherein step (a) comprises the following steps:
(A) providing bis(chlorosulfonyl)imide (HCSI);
(B) melting said bis(chlorosulfonyl)imide (HCSI) provided in step (a) to obtain a molten bis(chlorosulfonyl)imide (HCSI); and
(C) contacting said molten bis(chlorosulfonyl)imide (HCSI) obtained in step (b) with a compound of formula (I):
M⁺B⁻ (I)
wherein
M is selected from Na, Li, K, Ce, Rb and Fr and
B is selected from Cl; F; carbonate (CO₃⁻); sulfate (SO₄²⁻); carboxylate; silicate, borate, and mixtures thereof; and allow the reaction to proceed, to produce the salt of bis(chlorosulfonyl)imide,
wherein steps (B) and (C) are carried out in the absence of solvent.

6. The method according to claim 5, wherein step (C) comprises:
adding said compound of formula (I) to said molten bis(chlorosulfonyl)imide (HCSI), either progressively or at once; or
loading said compound of formula (I) into a reactor and adding said molten bis(chlorosulfonyl)imide (HCSI), either progressively or at once.

7. The method according to claim 5, wherein in said compound of formula (I), M is selected from Na, Li and K and/or B is selected from Cl, F, carbonate and sulphate.

8. The method according to claim 5, wherein:
step (B) is conducted at a temperature equal to or higher than 30° C.; and/or
step (C) is performed at a temperature equal to or higher than 37° C. and equal to or less than 220° C.; and/or
the molar ratio of the HCSI to the compound of formula (I) ranges from 0.001:1 to 20:1.

9. The method according to claim 5, wherein in said compound of formula (I) M is Li , said salt of bis(chlorosulfonyl)imide is LiCSI and:
step (C) is performed at a temperature between the melting point of HCSI (Tm₁) and the melting point of LiCSI (Tm₂) and the molar ratio HCSI to the compound of formula (I) is such that HCSI is the excess reactant; or
step (C) is performed at a temperature higher than or equal to the melting point of LiCSI (Tm2), the molar ratio HCSI to the compound of formula (I) is such that compound LiX is the excess reactant.

10. The method according to claim 5, wherein said compound of formula (I) is selected from the group consisting of lithium chloride (LiCl), lithium fluoride (LiF), lithium carbonate (Li₂CO₃), lithium sulphate (Li₂SO₄), lithium carboxylate (Liₙ(RCO₂)ₙ), Li₂SiO₃, Li₂B₄O₇ and mixtures thereof.

11. The method according to claim 5, wherein the hydrogen chloride (HCl) formed as a by-product during step (b) and/or step (c) is continuously removed from the reaction vessel during step (b) and/or step (c).

12. The method according to claim 5, said method comprising after step (C), a step (D) comprising the separation of the salt of bis(chlorosulfonyl)amide from the reaction mixture.

13. A lithium bis(fluoro sulfonyl)imide (LiFSI), obtained by the method according to claim 1.

14. A method comprising incorporating the lithium bis(fluorosulfonyl)imide (LiFSI) according to claim 13 in a non-aqueous electrolyte for batteries.

15. An electrolyte composition comprising the lithium bis(fluorosulfonyl) imide (LiFSI) according to claim 13.
